(19) United States
(12) Patent Application Publication
(10) Pub. No.: US 2015/0254535 A1
(43) Pub. Date: Sep. 10, 2015

(54) IMAGE PROCESSING APPARATUS AND IMAGE PROCESSING METHOD

(71) Applicant: CANON KABUSHIKI KAISHA, Tokyo (JP)

(72) Inventor: Ayumi Suzuki, Kawasaki-shi (JP)

(21) Appl. No.: 14/624,743

(22) Filed: Feb. 18, 2015

(30) Foreign Application Priority Data
Mar. 5, 2014 (JP) 2014-043151

(51) Int. Cl. G06K 15/02; G06F 3/12

(52) U.S. Cl. CPC G06K 15/024; G06K 15/1848; G06K 15/1842; G06F 3/1202; G06F 3/1243; G06F 3/125

(57) ABSTRACT

A third image is generated using an image obtained by rotating a second image by 180 degrees if designating being in an open state or a second image if designating being in a closed state. If being in the open state, an image obtained by coupling the first and third images while the lower side of the third image is aligned with a flap connecting side is generated as an image to be printed on a surface constituted by the obverse surface of an envelope and the flap. If being in the closed state, an image obtained by superimposing the third image on the first image while the upper side of the third image is aligned with the flap connecting side is generated as an image to be printed on a surface constituted by the reverse surface of the envelope and the flap.

### BACKGROUND OF THE INVENTION

1. Field of the Invention

The present invention relates to a technique for performing printing on an envelope.

2. Description of the Related Art

Due to an increase in performance of digital image forming apparatuses such as digital copying machines and digital multifunction peripherals, demand for printing a large number of envelopes for use in advertising and merchandising using printers or digital copying machines is growing. The address, company name, name of a person in charge, and the like of a destination are printed on the obverse surfaces of the main bodies of the envelopes, and the address, company name, name of a person in charge, and the like of a sender are printed on the reverse surfaces of the main bodies. Furthermore, a corporate logo and the like for advertising and merchandising are printed on the flap.

However, the envelopes on which printing is to be performed have a variety of shapes depending on usage, that is, some envelopes are on the market in the state in which their flaps are closed, some envelopes are on the market in the state in which their flaps are opened, and the envelopes have wide-ranging shapes in terms of width of their flaps and the like.

Japanese Patent Laid-Open No. 2012-187764 discloses a method in which, in order for an electrophotographic device to perform printing on an opened flap of an envelope, the image of the flap section is extracted from the image of the reverse surface of the main body of the envelope according to the size of the main body and the width and shape of the flap, and the extracted image is appropriately rotated and laid out.

In the electrophotographic device disclosed in the above-described Japanese Patent Laid-Open No. 2012-187764, however, printing on the obverse surface of the flap in the closed state is not taken into consideration. Even when printing is performed on envelopes whose flaps have the same shape, a user has to prepare different documents between when performing printing on an envelope with its flap open and when performing printing on an envelope with its flap closed.

If printing is performed on the main body and flap of the envelope with its flap open, a user needs an image in which an image that is to be printed on the obverse surface of the main body of the envelope with the flap closed and an image that is obtained by rotating an image to be printed on the obverse surface of the flap by 180 degrees are connected to each other.

On the other hand, if printing is performed on the main body and flap of the envelope with its flap closed, a user needs an image in which “the portion on which the folded flap is overlapped” of an image that is to be printed on the reverse surface of the main body of the envelope with the flap closed is replaced by “an image that is to be printed on the obverse surface of the flap”.

### SUMMARY OF THE INVENTION

The present invention was made in view of this problem, and provides a technique for appropriately laying out an image that is to be printed on the main body of an envelope and an image that is to be printed on the flap thereof, taking into consideration the open/closed state of the flap of the envelope on which printing is to be performed, thereby enabling printing.

According to the first aspect of the present invention, there is provided an image processing apparatus comprising: a unit configured to acquire a first image for use in printing on an obverse surface of an envelope with a flap in an open state or a reverse surface of the envelope with the flap in a closed state, and a second image for use in printing on the flap; a generation unit configured to generate an image that is to be printed on the flap, as a third image, using an image obtained by rotating the second image by 180 degrees if it is designated that the flap is in the open state or using the second image if it is designated that the flap is in the closed state; and a composition unit configured to generate, if it is designated that the flap is in the open state, an image obtained by coupling the first image and the third image while a lower side of the third image is aligned with a flap connecting side, which is assumed to be a side of the first image on which the flap is provided, as an image that is to be printed on a surface constituted by the obverse surface of the envelope and the flap, the composition unit being configured to generate, if it is designated that the flap is in the closed state, an image obtained by superimposing the third image on the first image while an upper side of the third image is aligned with the flap connecting side, as an image that is to be printed on a surface constituted by the reverse surface of the envelope and the flap.

According to the second aspect of the present invention, there is provided an image processing method performed by an image processing apparatus, the method comprising: an acquisition step of acquiring a first image for use in printing on an obverse surface of an envelope with a flap in an open state or a reverse surface of the envelope with the flap in a closed state, and a second image for use in printing on the flap; a generation step of generating an image that is to be printed on the flap, as a third image, using an image obtained by rotating the second image by 180 degrees if it is designated that the flap is in the open state or using the second image if it is designated that the flap is in the closed state; and a composition step of generating, if it is designated that the flap is in the open state, an image obtained by coupling the first image and the third image while a lower side of the third image is aligned with a flap connecting side, which is assumed to be a side of the first image on which the flap is provided, as an image that is to be printed on a surface constituted by the obverse surface of the envelope and the flap, or generating, if it is designated that the flap is in the closed state, an image obtained by superimposing the third image on the first image while an upper side of the third image is aligned with the flap connecting side, as an image that is to be printed on a surface constituted by the reverse surface of the envelope and the flap.

Further features of the present invention will become apparent from the following description of exemplary embodiments (with reference to the attached drawings).

### BRIEF DESCRIPTION OF THE DRAWINGS

FIG. 1 is a block diagram showing an example of a hardware configuration of an image processing apparatus.

FIG. 2 is a block diagram showing an example of a configuration of a computer program (software).

FIG. 3 is a diagram showing the relationships between the positions of the flaps of envelopes and the feed directions of the envelopes.

FIG. 4 is a diagram showing an example of display of a GUI.

FIG. 5 is a diagram showing an example of a configuration of a sheet attribute list.

FIG. 6 is a diagram showing an example of display of a GUI.

FIG. 7 is a flowchart of the procedure performed by an image processing apparatus 101.

FIG. 8 is a diagram showing the processing in step S703.

FIG. 9 is a diagram showing the processing in steps S706 and S707.

### DESCRIPTION OF THE EMBODIMENTS

Hereinafter, embodiments of the present invention will be described with reference to the accompanying drawings. Note that the embodiments below are examples when the present invention is specifically implemented, and are specific examples of configurations described in the claims.

An image processing apparatus according to the present embodiment is an apparatus that generates an image to be printed on a surface constituted by the obverse surface of an envelope with its flap open or the reverse surface of the envelope with its flap closed, and the flap, and prints the generated image on the surface. Note that in the description below, “flap” refers to, of course, the “surface of the flap that is opposite to the surface to be adhered to the envelope reverse surface”. Therefore, a region (surface) of a flap on which printing is performed is this “surface of the flap that is opposite to the surface to be adhered to the envelope reverse surface.

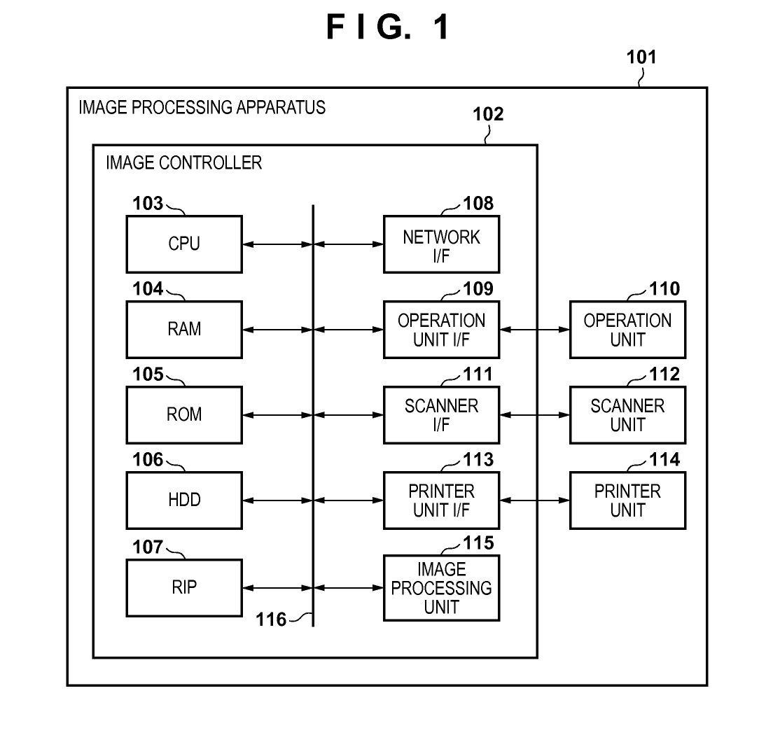

The following will describe an example of a hardware configuration of the image processing apparatus according to the present embodiment with reference to the block diagram of FIG. 1. Note that the configuration shown in FIG. 1 is merely an example of a configuration of the image processing apparatus capable of executing processing that will be described below, and the image processing apparatus may have any configuration as long as it can execute the processing that will be described below. An image processing apparatus 101 includes an image controller 102, an operation unit 110, a scanner unit 112, and a printer unit 114.

A CPU 103 performs control of overall operation of the apparatus by executing processing using a computer program and data stored in a RAM 104 or ROM 105, and executes processing that will be described later as being executed by the image controller 102.

The RAM 104 has an area in which data of an image transmitted from the scanner unit 112 via a scanner interface (I/F) 111, and computer programs and data that are loaded from the ROM 105 are stored. Furthermore, the RAM 104 has an area in which computer programs and data that are loaded from a hard disk drive (HDD) 106 is stored, and an area in which data externally received via a network I/F 108 is stored. Furthermore, the RAM 104 has a work area that is used by the CPU 103, a raster image processor (RIP) 107, and an image processing unit 115 when they execute various types of processing. That is, the RAM 104 can appropriately provide various types of areas.

The ROM 105 has stored computer programs and data for causing the CPU 103 to execute processing that will be described later as being executed by the image controller 102.

The HDD 106 can provide an area (for example, a swap region) in which data of an image transmitted from the scanner unit 112 via the scanner I/F 111 is stored, and that is used by the RIP 107 and image processing unit 115 when they execute various types of processing. That is, any one or both of the RAM 104 and the HDD 106 may be used as a memory for use in data storage in the processing that will be described below.

The RIP 107 converts a page-description language (PDL) in a print job that is loaded from the HDD 106 or externally received via the network I/F 108 into raster image data.

The network I/F 108 functions as an interface for connecting the present apparatus to a network such as the LAN or Internet, and the present apparatus can communicate data with devices on the network via this network I/F 108.

An operation unit I/F 109 is a communication I/F for controlling key-inputs from the connected operation unit 110 and display-outputs to the operation unit 110. The operation unit 110 includes hard keys and a touch panel screen. The states of the image processing apparatus 101 and various graphical user interfaces (GUIs) that will be described later are displayed on the touch panel screen. Furthermore, the touch panel screen detects various touch operations of a user and notifies the CPU 103 of the detection. Furthermore, the hard keys include a numerical keypad and the like, and the user can input various types of instructions into the CPU 103 by operating the hard keys.

A scanner I/F 111 is a communication I/F for controlling communication with the connected scanner unit 112, and is configured to transmit a control command to the scanner unit 112 and receive an image that was optically scanned by the scanner unit 112. The scanner unit 112 optically scans a document.

A printer unit I/F 113 is a communication I/F for controlling communication with the connected printer unit 114, and is configured to transmit a control command to the printer unit 114 and an image that is to be printed by the printer unit 114.

The image processing unit 115 performs image processing, such as magnification change, rotation, image shifting, color conversion, or smoothing, on an image scanned by the scanner unit 112, an image generated by the RIP 107, an image received via the network I/F 108, or the like.

All the functional units constituting the image controller 102 are connected to each other via a common bus 116, and can transmit and receive data to and from each other via this bus 116.

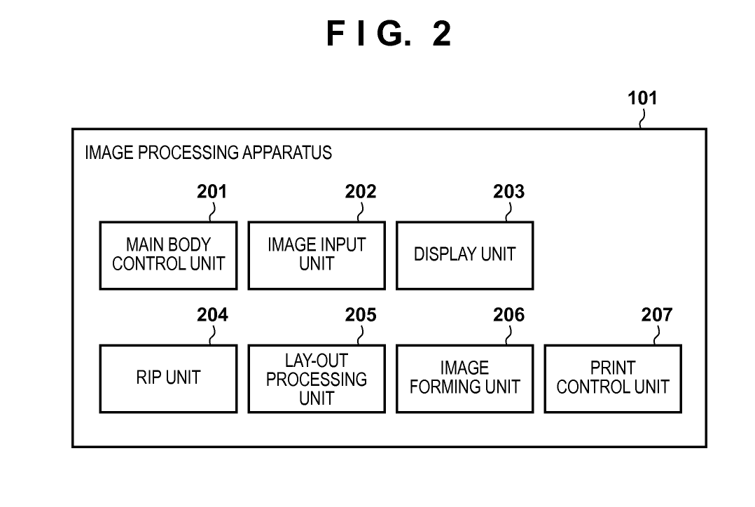

The following will describe an example of configurations of computer programs (software) stored in the ROM 105 with reference to the block diagram of FIG. 2. All of these computer programs are basically executed by the CPU 103, but some or all of the functions may also be executed by functional units other than the CPU 103. For example, parts of functions of a lay-out processing unit 205 and an image forming unit 206 may be executed by the image processing unit 115. Furthermore, for the sake of description, the following description may be made assuming that the functional units shown in FIG. 2 perform the processing, but actually the functions are realized by the CPU 103 executing programs corresponding to the functional units (computer programs).

A main body control unit 201 manages a print job or image that is received by an image input unit 202 via the network I/F 108, and performs printing using modules (functional units) 203 to 207.

The display unit 203 displays, using the operation unit 110, various types of information such as the job state of a print job, and various types of GUI that will be described later. Furthermore, the display unit 203 performs, using the operation unit 110, display to prompt a user operation, notifying of out of paper or jam, for example.

The RIP unit 204 uses the RIP 107 to convert the PDL included in the print job into raster image data. The lay-out processing unit 205 decides the layout of an image on a sheet by print setting. Examples of the processing include processing for deciding a normal image and an inverse image of the reverse surface by the double-sided print setting, processing for deciding a direction of an image so that stapling is possible at a designated staple position, centering of an image in case where the sizes of a sheet and the image do not match each other, and rotating of an image in the case of printing of an envelope based on the position of the flap thereof. Furthermore, the lay-out processing unit 205 lays out an image that is to be printed on the flap of an envelope, and an image that is to be printed on the portion other than the flap in accordance with the direction of the sheet.

The image forming unit 206 uses the image processing unit 115 to perform image processing such as color conversion or smoothing. The print control unit 207 controls the printer unit 114 to perform printing that will be described later.

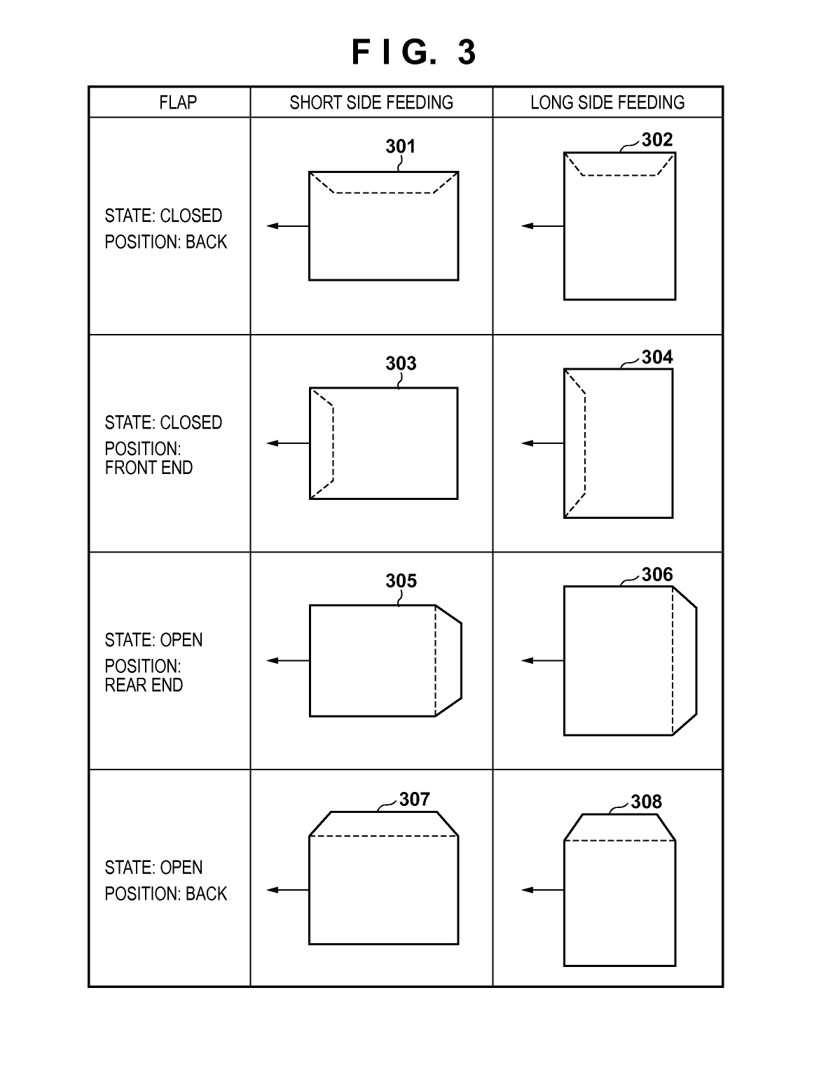

The following will describe the relationship between the positions of the flaps of envelopes and the feed directions of the envelopes with reference to FIG. 3. In FIG. 3, all reference numerals 301 to 308 denote the obverse surfaces of envelopes of the same size, and the envelopes 301, 304, 306, and 307 are envelopes whose flaps are provided on long sides thereof, and the envelopes 302, 303, 305, and 308 are envelopes whose flaps are provided on the short sides thereof. Furthermore, in FIG. 3, arrows denote the envelope feed directions in the printer unit 114 (that is, the envelope delivery directions in the printer unit 114), and in the present embodiment, eight types of feeding methods as shown in FIG. 3 are conceivable. Note that feeding by the same methods can be applied even to the case of the envelopes being reversed although it is not specifically shown.

The envelope 301 is a horizontally long envelope whose flap is provided on a long side thereof, and the flap is in the closed state. Therefore, the flap is in the state of being folded on the reverse (back) side of the envelope (the dotted line denotes the invisible sides of the flap folded on the reverse side). In the present embodiment, a method for feeding such an envelope 301 into the printer unit 114 includes a method of feeding (short side feeding) in the direction that is perpendicular to the short sides of the envelope 301.

The envelope 302 is a vertically long envelope whose flap is provided on a short side thereof, and the flap is in the closed state. In the present embodiment, a method for feeding such an envelope 302 into the printer unit 114 includes a method of feeding (long side feeding) in the direction that is perpendicular to the long sides of the envelope 302.

The envelope 303 is a vertically long envelope whose flap is provided on a short side thereof, and the flap is in the closed state. In the present embodiment, a method for feeding such an envelope 303 into the printer unit 114 includes a method of feeding (short side feeding) with the flap located at the front end.

The envelope 304 is a horizontally long envelope whose flap is provided on a long side thereof, and the flap is in the closed state. In the present embodiment, a method for feeding such an envelope 304 into the printer unit 114 includes a method of feeding (long side feeding) with the flap located at the front end.

The envelope 305 is a vertically long envelope whose flap is provided on a short side thereof, and the flap is in the open state. In the present embodiment, a method for feeding such an envelope 305 into the printer unit 114 includes a method of feeding (short side feeding) with the flap located at the rear end.

The envelope 306 is a horizontally long envelope whose flap is provided on a long side thereof, and the flap is in the open state. In the present embodiment, a method for feeding such an envelope 306 into the printer unit 114 includes a method of feeding (long side feeding) with the flap located at the rear end.

The envelope 307 is a horizontally long envelope whose flap is provided on a long side thereof, and the flap is in the open state. In the present embodiment, a method for feeding such an envelope 307 into the printer unit 114 includes a method of feeding (short side feeding) in the direction that is perpendicular to the short sides.

The envelope 308 is a vertically long envelope whose flap is provided on a short side thereof, and the flap is in the open state. In the present embodiment, a method for feeding such an envelope 308 into the printer unit 114 includes a method of feeding (long side feeding) in the direction that is perpendicular to the long sides.

Note that in the above-described example, when the envelope is fed with its flap directed in the feed direction or the direction opposite thereto (in any of the methods of feeding of the envelopes 303 to 306), the possibility that the flap section gets wrinkled should be taken into consideration. Accordingly, the flap is located at the front end in the feed direction when the flap is in the closed state, and the flap is located at the rear end in the feed direction when the flap is in the open state. However, in the case where there is no possibility that the flap section gets wrinkled, it is not needed to set the feed direction depending on the open/closed state of the flap as in the above-described case.

Furthermore, the long side feeding is more advantageous than the short side feeding in terms of performance if envelopes have the same size, but there is the possibility that the flap section gets wrinkled depending on the sheet type, and thus, in the present embodiment, the delivery directions of the short side feeding and the long side feeding are supported for the same envelope. The envelope feed directions are, of course, not limited to the directions shown in FIG. 3.

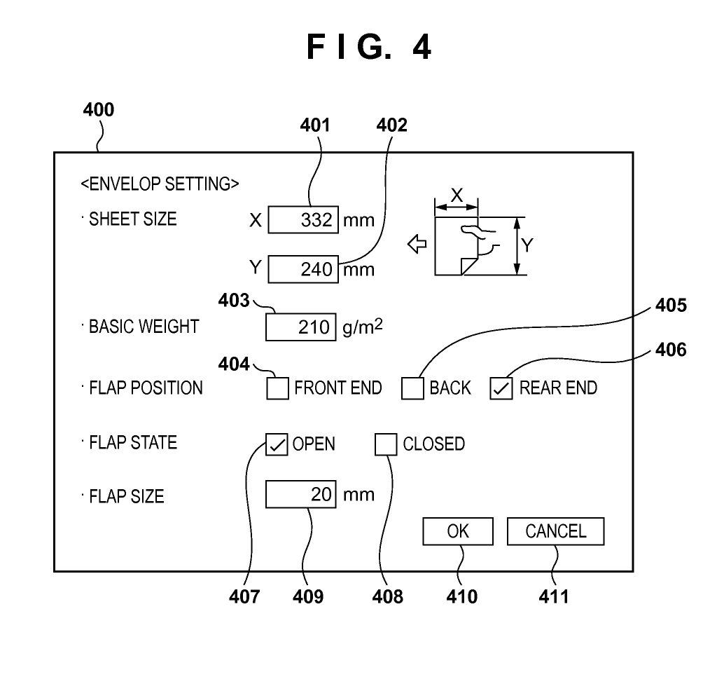

The following will describe envelope setting that is configured in advance for printing on an envelope. The envelope setting is configured, for example, by a GUI 400, exemplified in FIG. 4, being displayed on the touch panel screen of the operation unit 110, and a user touching the touch panel screen or operating the hard keys of the operation unit 110. The method for configuring envelope setting is, of course, not limited to the specific method, and it is also possible, for example, that envelope setting is configured using a device that is connected to the present apparatus via the network I/F 108 and the results of the setting is transmitted to the present apparatus. Note that it is assumed that the CPU 103 performs all of various types of processing in response to operations on the GUI 400, which is exemplified in FIG. 4.

Entry fields 401 and 402 are entry fields in which an envelope size (sheet size) is input. The entry field 401 is an entry field in which an envelope size (X) in the feed direction is input, and the entry field 402 is an entry field in which an envelope size (Y) in the direction perpendicular to the feed direction is input. Note that in the case where a standard size is designated as the envelope size, a user may display a list of standard sizes on the touch panel screen and select one of the standard sizes by touching that size. Furthermore, “sheet size” in this context refers to the size of an envelope excluding its flap, but may also refer to the size of an envelope including its flap depending on the configuration.

An entry field 403 is an entry field in which a basic weight is input. The basic weight is the number of grams per square meter of envelopes (sheets).

Check boxes 404 to 406 are check boxes for use in designating the position of a flap, indicating whether the flap is located at the front end or the rear end in the feed direction of an envelope or at the remaining position (back) that is other than the front end and the rear end, and the check boxes 404 to 406 perform toggle operation such that only one box is designatable.

When the check box 404 is designated, it is possible to designate that the flap is located at the front end in the feed direction of an envelope (for example, the flap position as in the case of the envelope 303 or 304). When the check box 406 is designated, it is possible to designate that the flap is located at the rear end in the feed direction of the envelope (for example, the flap position as in the case of the envelope 305 or 306). When the check box 405 is designated, it is possible to designate that the flap is provided on a side extending in the feed direction of an envelope (for example, the flap position as in the case of the envelope 301, 302, 307, or 308). FIG. 4 shows the state in which the check box 406 is designated.

Check boxes 407 and 408 are check boxes for use in designating the open/closed state (flap state) of the flap, and perform toggle operation such that only one box is designatable. When the check box 407 is designated, it is possible to designate that the flap is in the open state. When the check box 408 is designated, it is possible to designate that the flap is in the closed state. FIG. 4 shows the state in which the check box 407 is designated.

An entry field 409 is an entry field in which the length of the flap (flap width or flap size) in the direction perpendicular to the side on which the flap is provided is input. Note that when inputting data (numerical value) into the entry fields 401, 402, 403, and 409, the user first touches a target entry field on the touch panel screen, for example. Accordingly, the entry field is activated, and thus the user can input a numerical value in the activated entry field using the numerical keypad. The method for inputting data into the entry fields is, of course, not limited to this. Furthermore, in the designation operations on the check boxes 404 to 408, the user can designate a target check box by, for example, touching the target check box on the touch panel screen.

Note that there is the direction in which feeding is not possible depending on the envelope defined by the numerical values input into the entry fields 401 to 403, and the check box that corresponds to this feed direction, of the check boxes (404 to 406) for the flap positions, is controlled so as not to be designatable (undesignated state).

Furthermore, according to the present embodiment, as described with reference to FIG. 3, the feed directions and the flap positions are not irrelevant to each other but rather have the relationship as shown in FIG. 3. Therefore, the three check boxes 404 to 406 cannot always be designated, and the designatable check boxes vary depending on the numerical values input into the entry fields 401 and 402, and the state designated in the check boxes 407 and 408.

When, for example, X>Y and the check box 407 is designated, the feed direction of one of the envelopes 305 and 307 is enabled, and thus the check box 404 is controlled so as not to be designatable, and only the check boxes 405 and 406 are controlled so as to be designatable.

Furthermore, when, for example, X>Y and the check box 408 is designated, the feed direction of one of the envelopes 301 and 303 is enabled, and thus the check box 406 is controlled so as not to be designatable, and only the check boxes 404 and 405 are controlled so as to be designatable.

Accordingly, the designatable items and the undesignatable items are selectively controlled depending on the items designated on the GUI 400.

When the user touches an OK button 410 on the touch panel screen, the CPU 103 registers data on the items that were set using the GUI 400, as sheet information, in a list (sheet attribute list) managed in the HDD 106. Then, the CPU 103 closes the GUI 400, and displays an appropriate screen (for example, a default screen) on the touch panel screen.

On the other hand, when the user touches a cancel button 411 on the touch panel screen, the CPU 103 discards data on the items set using the GUI 400, closes the GUI 400, and displays an appropriate screen (for example, a default screen) on the touch panel screen.

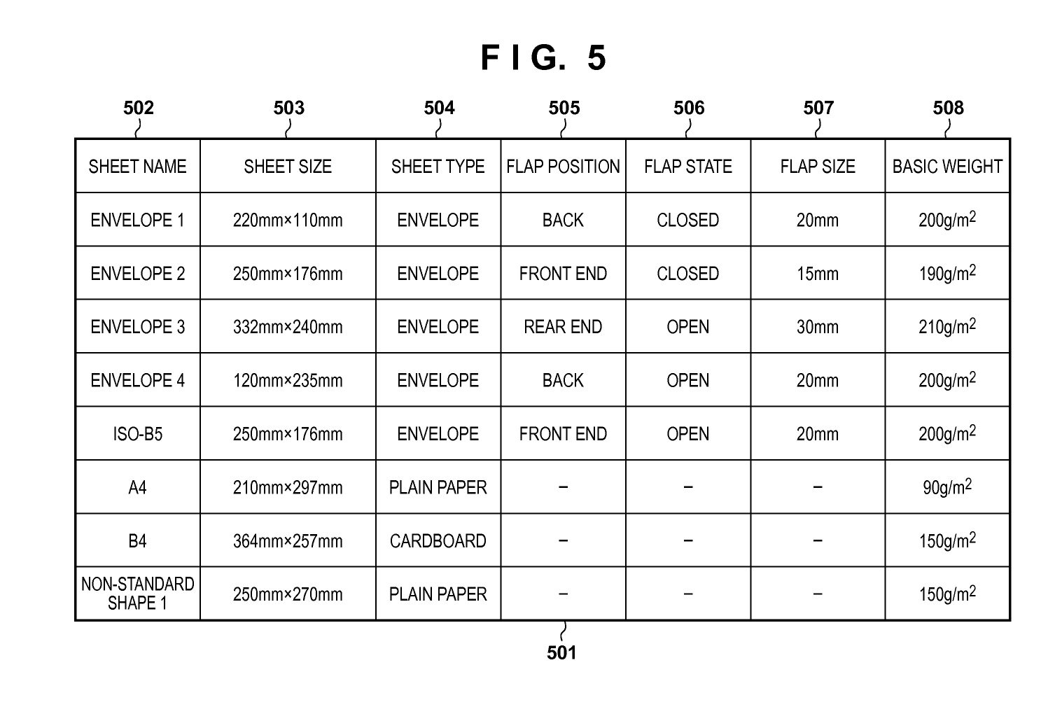

The following will describe an example of a configuration of the sheet attribute list into which sheet information is registered each time the sheet information is generated using the GUI of FIG. 4 with reference to FIG. 5. In the sheet attribute list, information on some standard-sized sheets are registered in advance, and sheet information generated using the GUI of FIG. 4 can later be registered additionally.

Furthermore, this sheet attribute list can be edited suitably. For example, when a user inputs an editing instruction using the operation unit 110, the CPU 103 reads this sheet attribute list from the HDD 106 and displays the read sheet attribute list on the touch panel screen. Then, when the user inputs an editing operation into the sheet attribute list using the operation unit 110, the CPU 103 updates the sheet attribute list in accordance with the editing operation. Then, when the user inputs an editing termination instruction by operating the operation unit 110, the CPU 103 stores the updated sheet attribute list into the HDD 106.

Sheet names are registered in a column 502.

Sheet sizes are registered in a column 503, that is, the sheet sizes (X×Y) defined by the numerical values input into the entry fields 401 and 402 are registered in this column 503. Types of sheets (sheet type) such as plain paper, cardboard, an envelope, and a postcard are registered in a column 504.

Flap positions are registered in a column 505, that is, the flap position that corresponds to the designated check box of the check boxes 404 to 406 is registered in this column 505. Flap states are registered in a column 506, that is, the flap state that corresponds to the designated one of the check boxes 407 and 408 is registered in this column 506.

Flap sizes are registered in a column 507, that is, the flap size input into the entry field 409 is registered in this column 507. Basic weights are registered in a column 508, that is, the basic weight input into the entry field 403 is registered in this column 508.

Note that information on some standard-sized sheets is registered in advance in the sheet attribute list, as described above. The information on the standard-sized sheets is <sheet name=A4, sheet size=210 mm×297 mm, sheet type=plain paper, basic weight=90 g/m²> and <sheet name=B4, sheet size=364 mm×257 mm, sheet type=cardboard, basic weight=150 g/m²> of FIG. 5. Furthermore, <sheet name=ISO-B5, sheet size=250 mm×176 mm, sheet type=envelope, flap position=front end, flap state=open, flap size=20 mm, basic weight=200 g/m²> is also the information on the standard-sized sheet. The information on these standard-sized sheets is registered in advance in the sheet attribute list.

Note that when registering the sheet information generated using the GUI of FIG. 4 into this sheet attribute list, the user inputs appropriate information into the columns 502 and 504 by operating the operation unit 110.

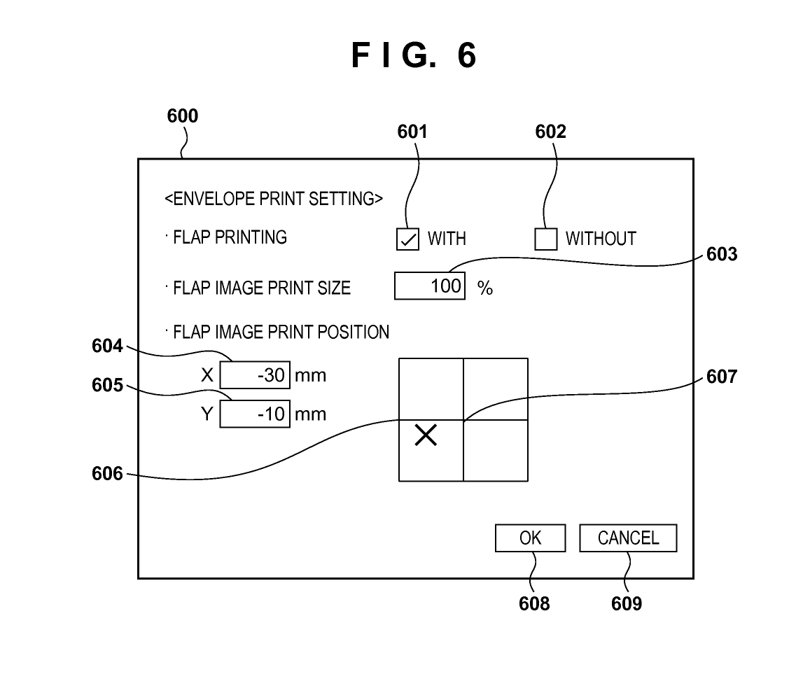

The following will describe print setting with respect to a flap. In the present embodiment, print setting with respect to a flap is assumed to be configured by a user operating a GUI 600, which is exemplified in FIG. 6, but any method may also be employed as long as the same print setting can be configured. The GUI 600 of FIG. 6 is displayed on the touch panel screen by the CPU 103 upon the user inputting an instruction to configure print setting with respect to a flap using the operation unit 110. Note that it is assumed that the CPU 103 performs all of various types of processing in response to operations on the GUI 600, which is exemplified in FIG. 6.

Check boxes 601 and 602 are check boxes for use in designating whether or not printing on a flap is performed, and perform toggle operation such that only one box is designatable. When the check box 601 is designated, it is possible to designate performing printing on a flap, and when the check box 602 is designated, it is possible to designate not performing printing on a flap.

Entry fields 603 to 605, which will be described below, are brought into the designatable state only when the check box 601 is designated, and are brought into the undesignatable state when the check box 602 is designated.

An entry field 603 is an entry field in which a reduction ratio of an original image that is to be printed on the flap is input, and is configured such that “r” is input when a reduced image obtained by reducing the original image by r % is to be printed on the flap. However, any information may be input as long as the information can designate the size of an image that is to be printed on the flap.

Entry fields 604 and 605 are entry fields in which an image print position on the flap at which the reduced image is to be printed is input. The present embodiment has a configuration in which an offset with respect to an origin is input as the image print position, where the central position of the flap in the closed state is set to the origin (0, 0). The entry field 604 is an entry field in which a position X on the axis (horizontal axis) along the side on which the flap is provided is input, and the entry field 605 is an entry field in which a position Y on the axis (vertical axis) perpendicular to the side on which the flap is provided is input. Therefore, when the user wants to set the central position of the flap as the image print position, the user only needs to input “0” in the entry fields 604 and 605. Furthermore, in the present embodiment, it is defined that the rightward direction along the horizontal axis is the direction in which the value of the position X increases, and the upward direction along the vertical axis is the direction in which the value of the position Y increases. In this case, when the user wants to set the position that is located 30 mm away from the origin in the leftward direction and 10 mm away from the origin in the downward direction as the image print position, the user only needs to input “−30” in the entry field 604 and “−10” in the entry field 605, as shown in FIG. 6. Note that the reference position of an offset is not limited to the origin, and the method of designating the image print position is not limited to the above-described method.

A region 606 indicates a surface of the flap in the closed state on which printing is to be performed, and a position 607 is the position in the region 606 that corresponds to the central position of the flap. In FIG. 6, since “−30” and “−10” are respectively input in the entry fields 604 and 605, “x” is indicated in the region 606 at the corresponding position (−30, −10).

The CPU 103 can execute the following control by configuring setting with respect to the above-described items of this GUI 600. That is, the CPU 103 decides the position to which a reduced image obtained by reducing an original image by the reduction ratio input in the entry field 603 is to be offset from the central position of the flap by the offset amount that is input in the entry fields 604 and 605. Accordingly, the CPU 103 can generate an image that is laid out so as to be printed at the decided position (so that the central position of the reduced image overlaps this position).

Note that when inputting data (numerical value) into the entry fields 603 to 605, the user first touches a target of the entry fields on the touch panel screen, for example. Accordingly, the entry field is activated, and thus the user can input a numerical value in the activated entry field using the numerical keypad. The method for inputting data into the entry fields is, of course, not limited to this. Furthermore, in the designation operations with respect to the check boxes 601 and 602, the user can touch a target of the check boxes on the touch panel screen and designate the target check box.

When the user touches an OK button 608 on the touch panel screen, the CPU 103 stores data on the items that were set using the GUI 600 in the HDD 106, as envelope print control information. Then, the CPU 103 closes the GUI 600, and displays an appropriate screen (for example, a default screen) on the touch panel screen.

On the other hand, when the user touches a cancel button 609 on the touch panel screen, the CPU 103 discards data on the items set using the GUI 600, closes the GUI 600, and displays an appropriate screen (for example, a default screen) on the touch panel screen.

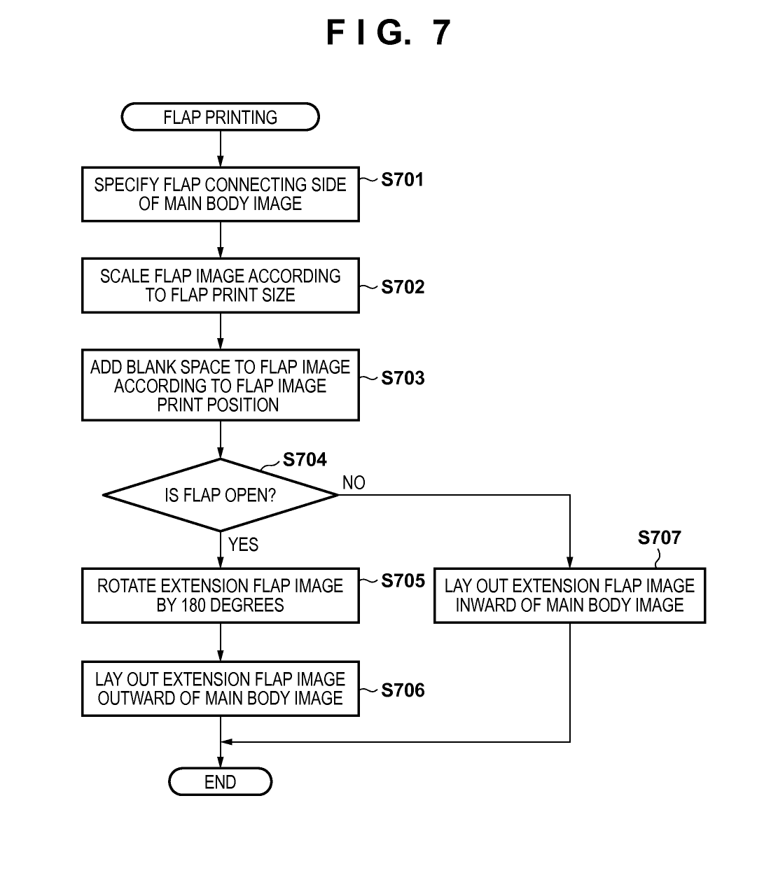

The following will describe the processing that the image processing apparatus 101 (image controller 102) performs in order to generate an image that is to be printed on a surface constituted by the obverse surface of an envelope with its flap open or the reverse surface of the envelope with its flap closed, and the flap with reference to the flowchart of that processing of FIG. 7. Note that computer programs (including computer programs corresponding to the functional units shown in FIG. 2) for causing the CPU 103 to execute the procedure according to the flowchart of FIG. 7 are stored in the HDD 106. Therefore, by loading and executing the computer programs on the RAM 104, the CPU 103 can execute the procedure according to the flowchart of FIG. 7.

Furthermore, it is assumed that at the time to start the procedure according to the flowchart of FIG. 7, the setting processing configured using the GUIs shown in FIGS. 4 and 6 has already been completed. It is furthermore assumed that a first image that is to be printed on the obverse surface of the envelope with its flap open or the reverse surface of the envelope with its flap closed, and a second image that is to be printed on that flap are stored in advance in the HDD 106.

Here, when the check box 407 is designated on the GUI 400 of FIG. 4 (flap state=open) with respect to an envelope on which printing is to be performed, the first image is an image that is to be printed on the obverse surface of the envelope. In this case, therefore, the flowchart of FIG. 7 is a flowchart of the procedure performed for generating an image that is to be printed on the surface constituted by the obverse surface of the envelope and the flap.

On the other hand, when the check box 408 is designated on the GUI 400 of FIG. 4 with respect to an envelope on which printing is to be performed (flap state=closed), the first image is an image that is to be printed on the reverse surface of the envelope. In this case, therefore, the flowchart of FIG. 7 is a flowchart of the procedures performed for generating an image that is to be printed on a surface constituted by the reverse surface of the envelope and the flap.

Furthermore, the method for acquiring the first image and the second image is not particularly limited to a specific acquiring method, and images converted from PDLs by the RIP 107 may also be acquired as the first and second images, or the images may also be acquired externally via the network I/F 108. Furthermore, images scanned by the scanner unit 112 may also be acquired as the first and second images.

In step S701, a side of the first image (main body image) that will be located on the flap side if the first image is printed on a surface on which printing is to be performed is specified as a flap connecting side. For example, in the case of the envelope 307 of FIG. 3, the first image is to be printed in a region (that is, the obverse surface) under the dotted line, and, in this case, the upper side of the first image serves as the flap connecting side since the flap is located directly above the first image. Various methods for specifying one of the four sides constituting the first image as the flap connecting side are conceivable, and the present invention is not limited to a specific method.

For example, it is also possible that information indicating which one of the four sides constituting the first image serves as the flap connecting side has been registered in advance in the header of the first image and is read, and the flap connecting side is specified based on the read information. Furthermore, it is also possible that, when the first image is acquired, the upper or left (or right) side is decided as the flap connecting side based on the aspect ratio of the first image. Furthermore, if the side of an envelope on which the flap is provided accords with the upper side of the first image, the upper side of the first image may also be decided as the flap connecting side. On the other hand, if they do not accord with each other, the first image may be rotated so that they accord with each other, and the side of the rotated first image that corresponds to the upper side of the first image before rotation may also be decided as the flap connecting side.

Then, in step S702, the image processing unit 115 performs processing for generating a reduced image by reducing the second image (flap image) by the reduction ratio input in the entry field 603.

In step S703, the image processing unit 115 is controlled to generate an extension flap image that is an image to be actually printed on the flap (coordinated operation of the CPU 103 and the image processing unit 115). The extension flap image is an image in which the reduced image is laid out so that the central position thereof overlaps the position that is offset from the central position of the extension flap image by the offsets input in the entry fields 604 and 605, and the space other than the reduced image is blank. In the present embodiment, the flap image is input into the present apparatus while being directed so as to be viewed on the reverse surface of the envelope in the state in which the flap is folded. Accordingly, the size in the horizontal direction of the extension flap image is the same as the size of the flap connecting side, and the size in the vertical direction of the extension flap image is the same as the size input in the entry field 409. Note that a user can reference setting contents that were set using the GUI of FIG. 4 with respect to an envelope that is to be subjected to the present processing, by reading setting contents that corresponds to the envelope in the sheet attribute list stored in the HDD 106.

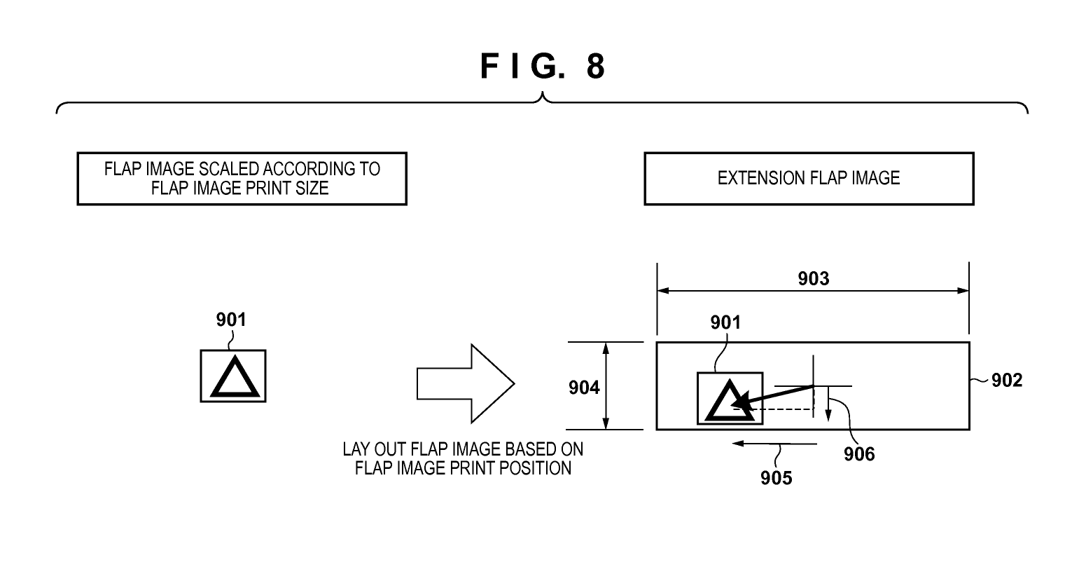

The processing in step S703 will be described with reference to FIG. 8. A reduced image 901 is arranged at a position that is offset in the horizontal direction from the central position of an extension flap image 902 by an offset 905 that is input in the entry field 604, and is offset in the vertical direction from the central position by an offset 906 that is input in the entry field 605. FIG. 8 shows the arrangement of the reduced image 901 when “−30” and “−10” are respectively input in the entry fields 604 and 605.

A size 903 in the horizontal direction of this extension flap image 902 is the same as that of the flap connecting side, and a size 904 in the vertical direction of the extension flap image 902 is the same as the size that was input in the entry field 409.

Then, in step S704, it is checked which of the check boxes 407 and 408 is designated. As a result of this check, if the check box 407 is designated, the procedure advances to step S705, and if the check box 408 is designated, the procedure advances to step S707.

In step S705, the image processing unit 115 performs processing for generating a rotated extension flap image, which is an image obtained by rotating the extension flap image generated in step S703 by 180 degrees.

In step S706, the image processing unit 115 performs processing for generating a composite image by coupling the first image and the rotated extension flap image while the lower side of the rotated extension flap image is aligned with the flap connecting side, as an image that is to be printed on the surface constituted by the obverse surface of the envelope and the flap.

On the other hand, in step S707, the image processing unit 115 performs processing for generating a composite image by superimposing the extension flap image on the first image while the upper side of the extension flap image is aligned with the flap connecting side, as an image that is to be printed on the surface constituted by the reverse surface of the envelope and the flap.

The print image (image generated in steps S706 and S707) that is generated in this manner is rotated according to the direction in which the envelope is directed, and is then printed on the envelope by the printer unit 114.

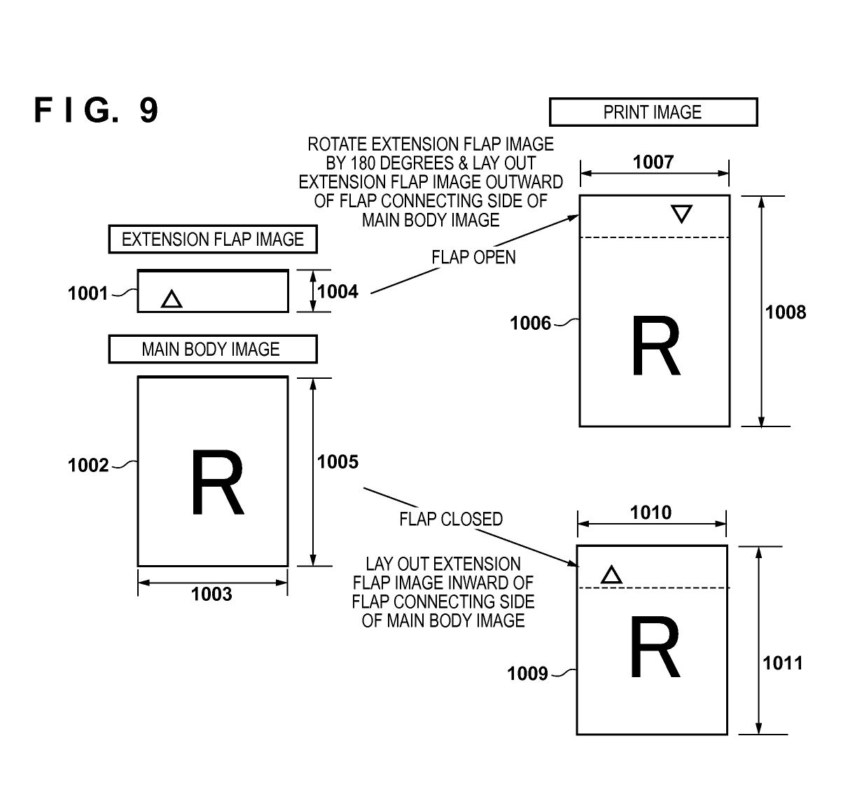

The print image generating processing in steps S706 and S707 will be described with reference to FIG. 9.

A size 1004 in the vertical direction of an extension flap image 1001 is the same as the size that was input in the entry field 409. Furthermore, the size in the horizontal direction of the extension flap image 1001 is the same as a size 1003 (that is, the length of the flap connecting side) in the horizontal direction of a main body image 1002. A size 1005 in the vertical direction of the main body image 1002 is the same as the length of the side of the envelope on which no flap is provided.

Here, if the check box 407 is designated, that is, the flap in the “open” state is designated, the rotated extension flap image, which is an image obtained by rotating the extension flap image 1001 by 180 degrees, is first generated. Then, a composite image (print image) 1006 obtained by coupling the main body image 1002 and the rotated extension flap image is generated while the lower side of the rotated extension flap image is aligned with the flap connecting side (heavy line) of the main body image 1002.

A size 1007 in the horizontal direction of this composite image 1006 is the same as the size in the horizontal direction of the extension flap image 1001 (size 1003 in the horizontal direction of the main body image 1002). Furthermore, a size 1008 in the vertical direction of the composite image 1006 is the size obtained by summing up the size 1004 in the vertical direction of the extension flap image 1001 and the size 1005 in the vertical direction of the main body image 1002.

On the other hand, if the check box 408 is designated, that is, the flap in the “closed” state is designated, the following control is performed. That is, a composite image (print image) 1009, which is obtained by superimposing the extension flap image 1001 on the main body image 1002 while the upper side of the extension flap image 1001 is aligned with the flap connecting side of the main body image 1002, is generated.

A size 1010 in the horizontal direction of this composite image 1009 is the same as the size in the horizontal direction of the extension flap image 1001 (size 1003 in the horizontal direction of the main body image 1002). Furthermore, a size 1011 in the vertical direction of the composite image 1009 is the same as the size 1005 in the vertical direction of the main body image 1002.

Note that in the present embodiment, irrespective of the flap state, the position of the reduced image in the extension flap image is the position that is offset from the central position of the extension flap image by offsets that were input in the entry fields 604 and 605. However, if the flap is in the “open” state, the extension flap image will be rotated by 180 degrees, and thus, depending on the situation, it may be desired that the positive or negative reference of a value input in the entry field 605 is inverted and then this value is used.

Furthermore, in the present embodiment, the image printing apparatus performs the processing for generating an image that is to be printed on a surface constituted by the obverse surface of an envelope with its flap open or the reverse surface of the envelope with its flap closed, and the flap. However, it is also possible that such an image is generated by an external apparatus, and is supplied to the printing apparatus.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-043151, filed Mar. 5, 2014 which is hereby incorporated by reference herein in its entirety.

What is claimed is:

1. An image processing apparatus comprising:
a unit configured to acquire a first image for use in printing on an obverse surface of an envelope with a flap in an open state or a reverse surface of the envelope with the flap in a closed state, and a second image for use in printing on the flap;
a generation unit configured to generate an image that is to be printed on the flap, as a third image, using an image obtained by rotating the second image by 180 degrees if it is designated that the flap is in the open state or using the second image if it is designated that the flap is in the closed state; and
a composition unit configured to generate, if it is designated that the flap is in the open state, an image obtained by coupling the first image and the third image while a lower side of the third image is aligned with a flap connecting side, which is assumed to be a side of the first image on which the flap is provided, as an image that is to be printed on a surface constituted by the obverse surface of the envelope and the flap, the composition unit being configured to generate, if it is designated that the flap is in the closed state, an image obtained by superimposing the third image on the first image while an upper side of the third image is aligned with the flap connecting side, as an image that is to be printed on a surface constituted by the reverse surface of the envelope and the flap.

2. The image processing apparatus according to claim 1, further comprising:
a print unit configured to print, if it is designated that the flap is in the open state, the image obtained by coupling the first image and the third image while the lower side of the third image is aligned with the flap connecting side, on the surface constituted by the obverse surface of the envelope and the flap, the print unit being configured to print, if it is designated that the flap is in the closed state, the image obtained by superimposing the third image on the first image while the upper side of the third image is aligned with the flap connecting side, on the surface constituted by the reverse surface of the envelope and the flap.

3. The image processing apparatus according to claim 1,
wherein the generation unit generates, as the third image, an image obtained by rotating an image that has the same size as that of the flap and includes a reduced image of the second image by 180 degrees, if it is designated that the flap is in the open state.

4. The image processing apparatus according to claim 1,
wherein the generation unit generates, as the third image, an image that has the same size as that of the flap and includes a reduced image of the second image, if it is designated that the flap is in the closed state.

5. The image processing apparatus according to claim 3, further comprising:
a unit configured to designate a position of the reduced image in the third image.

6. An image processing method performed by an image processing apparatus, the method comprising:
an acquisition step of acquiring a first image for use in printing on an obverse surface of an envelope with a flap in an open state or a reverse surface of the envelope with the flap in a closed state, and a second image for use in printing on the flap;
a generation step of generating an image that is to be printed on the flap, as a third image, using an image obtained by rotating the second image by 180 degrees if it is designated that the flap is in the open state or using the second image if it is designated that the flap is in the closed state; and
a composition step of generating, if it is designated that the flap is in the open state, an image obtained by coupling the first image and the third image while a lower side of the third image is aligned with a flap connecting side, which is assumed to be a side of the first image on which the flap is provided, as an image that is to be printed on a surface constituted by the obverse surface of the envelope and the flap, or generating, if it is designated that the flap is in the closed state, an image obtained by superimposing the third image on the first image while an upper side of the third image is aligned with the flap connecting side, as an image that is to be printed on a surface constituted by the reverse surface of the envelope and the flap.

7. A non-transitory computer-readable storage medium storing a computer program for causing a computer to function as the units of the image processing apparatus according to claim 1.
